(19) United States
(12) Patent Application Publication
(10) Pub. No.: US 2009/0177387 A1
(43) Pub. Date: Jul. 9, 2009

(54) Method of planning pedestrian navigation route

(75) Inventor: Neng Liu, Hsinchu City (TW)

Correspondence Address: BACON & THOMAS, PLLC, 625 SLATERS LANE, FOURTH FLOOR, ALEXANDRIA, VA, 22314-1176, US

(73) Assignee: Mitac International Corp., Taoyuan (TW)

(21) Appl. No.: 12/222,607

(22) Filed: Aug. 13, 2008

(30) Foreign Application Priority Data
Jan. 7, 2008 (TW) 097100524

(51) Int. Cl. G01C 21/34

(52) U.S. Cl. 701/209

(57) ABSTRACT

The present invention discloses a method of planning a pedestrian navigation route, and the method is applied to a pedestrian navigation device. The pedestrian navigation device includes a map database having a pedestrian road data and a driving route data of at least one public transportation means. In the method, when the pedestrian navigation device is planning a pedestrian navigation route, the pedestrian navigation device reads start position information and end position information, plans a pedestrian road and a driving route of different public transportation means between a start position and an end position according to a pedestrian road data and a driving route data, and then compiles the same into a pedestrian navigation route. The invention allows a pedestrian to reach an end position (or destination) selectively by walking along the planned pedestrian road or taking a ride of the selected public transportation means.

### FIELD OF THE INVENTION

The present invention relates to a method of planning a route, and more particularly to a method of planning a pedestrian navigation route for allowing a pedestrian to reach a destination selectively by walking along a pedestrian road or taking a ride of a public transportation means.

### BACKGROUND OF THE INVENTION

At early stage, Global Positioning System (GPS) was applied in the area of navigation for transportation means such as airplanes, motor vehicles and motorcycles. For instance, a vehicle navigation device used in a car comprises a GPS and a map database, and the vehicle navigation device outputs a map on a display device of the vehicle navigation device according to the map database, calculates the speed and direction of a car at a position from the current position of the car by a dead-reckoning principle, and marks a sign on the map to indicate the current position of the car.

The vehicle navigation device further installs pedestrian software and uses the pedestrian software to calculate a navigation route between a start position and an end position according to different navigation conditions (such as distance, type of road, and transportation means). If a user selects one of the navigation routes, the map will show the corresponding route provided as a reference for the user. If the vehicle navigation device uses the pedestrian software to calculate the current position of a car according to a positioning signal of the GPS and the car is no longer on the navigation route, the vehicle navigation device will use the pedestrian software to plan a new navigation route according to the current position of the car and the end position. From the description above, the vehicle navigation device uses the GPS, the map database and the pedestrian software to guide drivers to drive to the end position (or destination).

Since a pedestrian route may vary unexpectedly and people would do things like taking a shortcut, entering and exiting buildings, stopping, taking off or changing the walking direction all in a sudden, these walking behaviors make the positioning and navigation functions of the vehicle navigation device unable to satisfy the requirement of pedestrians and the expectation of consumers. In recent years, electronic communication technology advances, so that GPS can be operated with other technologies and applied in the area of pedestrian navigation to satisfy consumer requirements. For example, an assisted global positioning System (A-GPS) is capable of receiving positioning signals from a GPS, and also using a signal from a mobile phone base station to assist the positioning and overcome the shortcoming of the GPS that cannot receive satellite signals indoors, so as to achieve the positioning effect.

In the description above, the pedestrian navigation device uses the A-GPS to solve most of the pedestrian positioning problems, and the navigation technology of the pedestrian navigation device simply adopts the GPS, map database and pedestrian software of a vehicle navigation device for planning a pedestrian navigation route. However, the navigation route of the vehicle navigation device is designed primarily for driving on a road such as a highway or an expressway, but the design has not taken the roads for pedestrians into consideration, and thus the navigation route provided by the vehicle navigation device is not suitable for pedestrian navigations. Some manufacturers attempt to use a navigation route provided by a motorcycle navigation mode of the vehicle navigation device for the pedestrian navigation route. Although the pedestrian navigation route can provide a pedestrian road, it is inappropriate to mark a navigation route if the distance between the current position (start position) and the end position is over tens of kilometers or even hundreds of kilometers. In general, we may consider taking a ride of a public transportation means from the current position (or start position) to the end position. Therefore, finding a way of developing a pedestrian navigation device designated for pedestrians to reach the end position selectively by walking on a pedestrian road or taking a ride of a public transportation means demands immediate attentions and feasible solutions.

### SUMMARY OF THE INVENTION

In view of the foregoing shortcomings of the prior art, the inventor of the present invention based on years of experience in the related industry to conduct extensive researches and experiments, and finally designed a method of planning a pedestrian navigation route in accordance with the present invention to overcome the shortcomings of the prior art.

Therefore, it is a primary objective of the present invention to provide a method of planning a pedestrian navigation route, and the method is applied to a pedestrian navigation device. The pedestrian navigation device comprises a map database having a pedestrian road data and a driving route data of at least one public transportation means (such as bus, mass rapid transit, train and air transport). In the method, when the pedestrian navigation device is planning a pedestrian navigation route, the pedestrian navigation device reads start position information and end position information, plans a pedestrian road and a driving route of a public transportation means between the start and end positions according to a pedestrian road data and a driving route data, and then compiles the same into a pedestrian navigation route for overcoming the problem of the conventional navigation device that plans a pedestrian navigation route by the pedestrian road only, so as to allow a pedestrian to reach a destination selectively by walking along a pedestrian road or taking a ride of a public transportation means.

The above and other objects, features and advantages of the present invention will become apparent from the following detailed description taken with the accompanying drawings.

### BRIEF DESCRIPTION OF THE DRAWINGS

FIG. 1 is a schematic block diagram of a structure of a pedestrian navigation device in accordance with the present invention;

FIG. 2 is a flow chart of planning a pedestrian navigation route by a pedestrian navigation device in accordance with the present invention;

FIG. 3 is a flow chart of reading start position information and end position information by a pedestrian navigation device in accordance with the present invention;

FIG. 4 is a flow chart of compiling a pedestrian navigation route by a pedestrian navigation device in accordance with the present invention; and

FIG. 5 is a flow chart of planning another pedestrian navigation route by a pedestrian navigation device in accordance with the present invention.

### DETAILED DESCRIPTION OF THE PREFERRED EMBODIMENTS

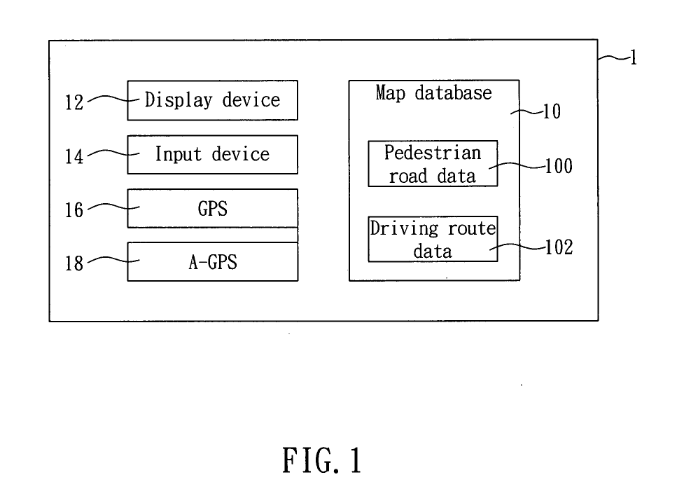

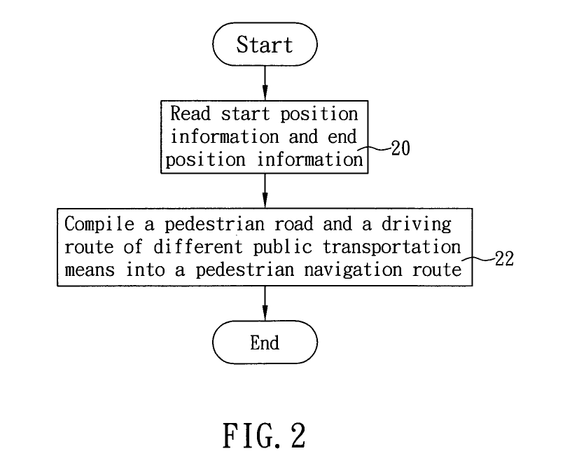

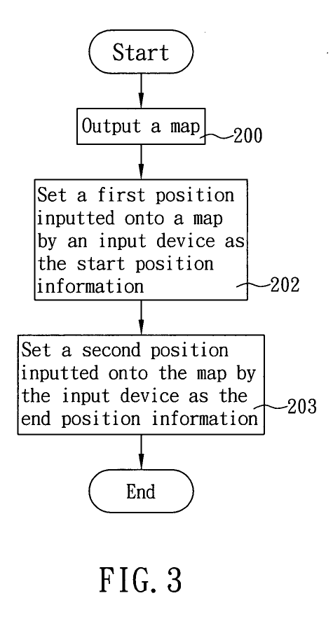

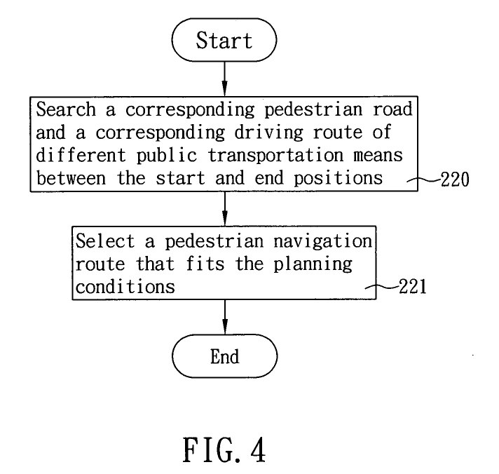

With reference to FIG. 1 for a method of planning a pedestrian navigation route in accordance with the present invention, the method is applied to a pedestrian navigation device. The pedestrian navigation device 1 comprises a map database 10 having a pedestrian road data 100 and a driving route data 102 of at least one public transportation means (such as a bus, a mass rapid transit, a train, an air transport and a sea transport). When the pedestrian navigation device 1 is planning a pedestrian navigation route according to the method as shown in FIG. 2, the pedestrian navigation device 1 processes a procedure comprising the steps of:
(20) reading start position information and end position information; wherein the procedure for the pedestrian navigation device 1 to read the start position information and the end position information in accordance with the method as shown in FIG. 3 comprises the steps of:
   (200) outputting a map by the pedestrian navigation device 1 through a display device 12 (such as an LCD screen) of the pedestrian navigation device 1 according to the map database;
   (202) inputting a first position (such as clicking a railway station A shown on the map) onto the map by an input device 14 (such as a keyboard, a touch screen display device, a mouse or a trackball of a navigation device 1), and setting the coordinates (such as latitude and longitude) of the first position as the start position information by the pedestrian navigation device 1; and
   (203) inputting a second position (such as clicking a location of a company B shown on the map) on the map by the input device 14, and setting the coordinates (such as latitude and longitude) of the second position as the end position information by the pedestrian navigation device 1;
(22) planning a pedestrian road and a driving route of different public transportation means between the start and end positions according to the pedestrian road data 100 and the driving route data 102, and compiling the same into a pedestrian navigation route, wherein the pedestrian navigation device 1 of the invention as shown in FIG. 4 compiles the pedestrian navigation route by a procedure comprising the steps of:
   (220) searching a corresponding pedestrian road and a corresponding driving route of different public transportation means from the pedestrian road data 100 and the driving route data 102 of different public transportation means between the start and end positions; and
   (221) selecting a pedestrian road and a driving route of different public transportation means between the start and end positions that satisfy at least one planning condition inputted by the input device 14 into the pedestrian navigation device 1 and compiling the same into the pedestrian navigation route, wherein each planning condition of the invention includes a sequence of transportation means such as a bus priority, a mass rapid transit priority, a train priority, an air transport priority or a sea transport priority, or the shortest distance, the shortest time or the least expenses incurred between the start position and the end position.

The present invention solves the problem of a conventional navigation device that simply plans a pedestrian navigation route by a pedestrian road only, and the invention allows a pedestrian to reach the end position selectively walking along a pedestrian road or taking a ride of a public transportation means.

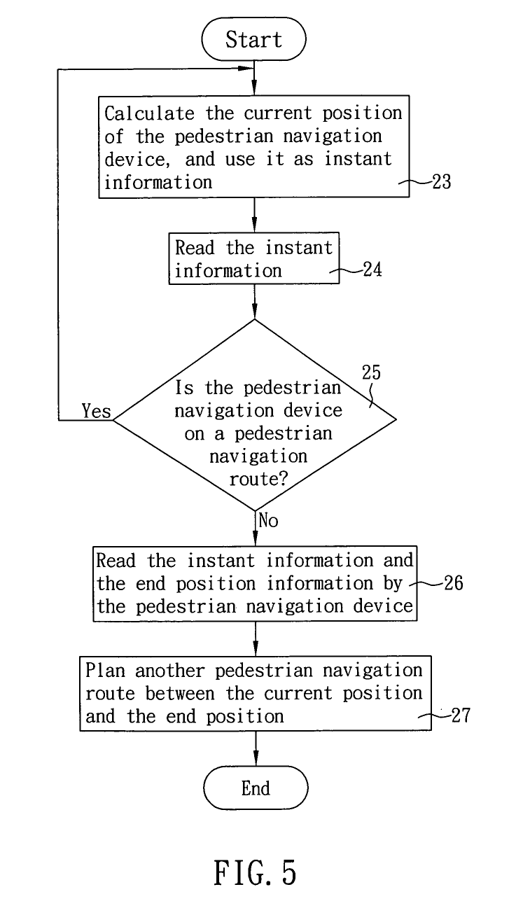

With reference to FIG. 1 again for a preferred embodiment of the present invention, the pedestrian navigation device 1 further comprises a global positioning system (GPS) 16 as shown in FIG. 5, such that when the pedestrian navigation device 1 plans the pedestrian navigation route, the pedestrian navigation device will process a procedure comprising the steps of:
(23) calculating the current position of the pedestrian navigation device 1 according to a satellite positioning signal of the GPS 16, and using the current position as instant information;
(24) reading the instant information;
(25) determining whether or not the pedestrian navigation device 1 is on the pedestrian navigation route according to the instant information; if yes, then go to Step (13), or else go to Step (16);
(26) reading the instant information and the end position information by the pedestrian navigation device 1 again; and
(27) planning a pedestrian road and a driving route of different public transportation means between the current position and the end position according to the pedestrian road data and driving route data, and compiling the same into another pedestrian navigation route.

From the description above, the pedestrian navigation device 1 can make a change to the pedestrian navigation route anytime to cope with a change of the pedestrian route.

In the preferred embodiment as shown in FIG. 1, the pedestrian navigation device 1 further comprises an assisted global positioning system (A-GPS) 18 calculates the current position of the pedestrian navigation device 1 according to a satellite positioning signal of the GPS 16 and a communication signal of the A-GPS 18, so that the pedestrian navigation device 1 can determine the current position of the pedestrian navigation device 1 more accurately to allow the pedestrian navigation device 1 to control a change of the pedestrian route and make a change to the pedestrian navigation route anytime.

In the preferred embodiment as shown in FIG. 1, the pedestrian navigation device 1 determines a public transportation means in the pedestrian navigation route, and calculates a ticket price of reach public transportation means and a total ticket price of different public transportation means according to the planning condition, and outputs and displays the results on the display device 12, such that a user can know about the expense incurred for traveling from the start position (or current position) to the end position and select one of the pedestrian navigation route routes that meets the user's requirement. In the preferred embodiment, the pedestrian navigation device 1 calculates the time required to reach the end position by walking along a pedestrian road or taking a ride of a public transportation means on the pedestrian navigation route according to the planning condition, and outputs and displays the result on the display device 12, such that the user can know about the time required to reach the end position from the start position and select one of the pedestrian navigation routes that fits the requirement of the pedestrian navigation route.

In the preferred embodiment as shown in FIG. 1, the pedestrian navigation device 1 outputs a hint information such as an alarm tone or a vibration at a predetermined distance or a predetermined time before the public transportation means reaches a predetermined transfer station on the pedestrian navigation route. Therefore, the user can take a rest or a nap while traveling on the public transportation means.

While the invention herein disclosed has been described by means of specific embodiments, numerous modifications and variations could be made thereto by those skilled in the art without departing from the scope and spirit of the invention set forth in the claims.

What is claimed is:

1. A method of planning a pedestrian navigation route, applied to a pedestrian navigation device, wherein the pedestrian navigation device comprises a map database, the map database comprises a pedestrian road data and a driving route data of at least one public transportation means, and the method for planning the pedestrian navigation route by the pedestrian navigation device comprises the steps of:
reading start position information and end position information inputted into the pedestrian navigation device; and
planning a pedestrian road and a driving route of different public transportation means between a start position and an end position according to the pedestrian road data and the driving route data, and compiling the same into the pedestrian navigation route.

2. The method of claim 1, wherein the step of reading the start position information and the end position information by the pedestrian navigation device comprises the steps of:
outputting a map from a display device of the pedestrian navigation device according to the map database;
reading the first position inputted onto the map by an input device of the pedestrian navigation device, and setting coordinates of the first position as the start position information; and
reading the second position inputted onto the map by the input device, and setting the second position as the end position information.

3. The method of claim 2, wherein the step of compiling into the pedestrian navigation route by the pedestrian navigation device comprises:
searching the pedestrian road and the driving route of different transportation means between the start position and the end position from the pedestrian road data and each of the public driving route data; and
selecting the pedestrian road and the driving route of different public transportation means between the start and end positions that satisfies at least one planning condition inputted into the navigation device, and compiling the same into the pedestrian navigation route.

4. The method of claim 3, wherein the planning condition is one selected from the collection of a bus priority, a mass rapid transit priority, a train priority, an air transport priority, a sea transport priority, the shortest distance, the shortest time, and the least expense from the start position to the end position.

5. The method of claim 4, wherein the pedestrian navigation device further comprises a global positioning system (GPS), such that if the pedestrian navigation device has planned the pedestrian navigation route, the pedestrian navigation device will process a procedure comprising the steps of:
calculating a current position of the pedestrian navigation device according to a satellite positioning signal of the GPS, and using the current position as instant information;
reading the instant information;
determining whether or not the pedestrian navigation device is on the pedestrian navigation route according to the instant information;
reading the instant information and the end position information again by the pedestrian navigation device, when the pedestrian navigation device is determined to be not on the pedestrian navigation route; and
planning the pedestrian road and the driving route of different public transportation means between the current position and the end position according to the pedestrian road data and the driving route data, and compiling the same into another pedestrian navigation route.

6. The method of claim 5, wherein the pedestrian navigation device further comprises an assisted global positioning system (A-GPS), and the pedestrian navigation device calculates the current position of the pedestrian navigation device according to the satellite positioning signal of the GPS and a communication signal of the A-GPS.

7. The method of claim 6, wherein the pedestrian navigation device determines different public transportation means required by each pedestrian navigation route and calculates a ticket price of each public transportation means and a total ticket price of different public transportation means according to the planning condition, and outputs and displays the selected result of public transportation means, the ticket price, and the total ticket price on the display device.

8. The method of claim 6, wherein the pedestrian navigation calculates the time required to reach the end position by walking along the pedestrian road or taking a ride of the public transportation means in the pedestrian navigation route according to the planning condition, and outputs and displays a calculated result of the time on the display device.

9. The method of claim 6, wherein the pedestrian navigation device outputs hint information before each of the public transportation means arrives a predetermined distance from a predetermined transfer station of the pedestrian navigation route.

10. The method of claim 6, wherein the pedestrian navigation device outputs hint information at a predetermined time before each of the public transportation means arrives a predetermined transfer station of the pedestrian navigation route.
